(19) United States
(12) Patent Application Publication
(10) Pub. No.: US 2003/0056133 A1
(43) Pub. Date: Mar. 20, 2003

(54) Printer wake up icon apparatus and method

(76) Inventor: Christopher Leon Talley, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/957,333

(22) Filed: Sep. 20, 2001

(51) Int. Cl. G06F 1/26; G06F 1/28; G06F 1/30

(52) U.S. Cl. 713/323

(57) ABSTRACT

In a computer system of a networked computer and printer, a printer wake up icon apparatus and method includes a computer and a network connected to the computer. A printer is connected to the network and through the network to the computer. A wake up icon is provided on the computer for sending a wake up command to the printer. In a further aspect of the invention, multiple computers are connected to the printer and/or multiple printers are connected to the computer. In a further aspect of the invention, the wake up icon resides on a desktop user interface on the computer.

### FIELD OF THE INVENTION

This invention relates to a printer wake up apparatus and method. In particular, the invention relates to a printer wake up icon apparatus and method in a computer system of a networked computer and printer.

### BACKGROUND OF THE INVENTION

As is often the case, an advance in one area of endeavor results in a decline in another area. In businesses, there can be no doubt that the advent of computers and printers has been an advance. Nonetheless, increased use of computers has resulted in delays. As more computers are connected to printers, users have found, for example, that a delay in printing information they have processed on their computer may result in the print job being postponed by pending jobs ahead of it.

Any delay is a source of frustration, and even a seemingly small delay is an aggravation at a minimum and a costly waste of time over the long run. One specific type of delay is common in printers. The delay occurs once a user has prepared information for printing and, accessing the user interface on the computer desktop, clicks on the print icon which sends the information to be printed to the selected printer. At this point, it is common for a user to walk to the distributed printer to retrieve the print job only to find that the printer is still warming up from its “power save” mode.

Prior art attempts to solve the problem are costly. One solution is to provide a printer for every computer whereby the printer is located directly next to the user so that the user can control the status of the printer directly. Even in a small business, this is a costly and unacceptable solution. Another solution that is not quite so costly, is to disable or somehow circumvent the power save mode such that the printer is in a “warmed up” mode at all times. Here of course, the extra wear and tear on the printer and the extra cost for keeping it always on, are prohibitive.

In the end, to date, there has been no known simple, economical and efficient way to avoid the lost time spent waiting for a printer to warmup and calibrate as it comes out of the power save mode in response to a print command.

Thus, there is a need in the art for providing an apparatus and method for waking up a printer prior to sending the print command.

### SUMMARY OF THE INVENTION

Accordingly, in a computer system of a networked computer and printer, a printer wake up icon apparatus and method of the present invention includes a computer and a network connected to the computer. A printer is connected to the network and through the network to the computer. A wake up icon on the computer is provided for sending a wake up command to the printer. In one aspect of the invention, multiple computers are connected to the printer. In another aspect of the invention, multiple printers are connected to the computer. In a further aspect of the invention, multiple computers and multiple printers are connected through the network.

In another aspect of the invention, the network is an intranet or the Internet. In a further aspect of the invention, the wake up icon resides on the computer's desktop user interface.

In another preferred embodiment of the invention, in a computer system of networked computers and distributed printers, a printer wake up icon apparatus includes at least one computer device, with a desktop user interface, for processing information. A network device for connecting electronic devices is connected to the computer device and a distributed printer device for printing hard copies of processed information is connected to the at least one computer device through the network device. Further, a printer wake up icon resides on the desktop user interface.

In another preferred embodiment of the invention, a method of warming up a printer in a computer system of at least one computer networked with a printer includes the steps of providing at least one computer and connecting the at least one computer to a network. A printer is connected to the network and thereby to the at least one computer. A wake up icon device is added to the at least one computer for sending a wake up signal to the printer. The wake up icon device is activated and sends a wake up signal to the printer before or during the preparation of information to be printed. Thereafter, the user sends the information to be printed to the printer which, at this point, is warmed up and ready to print.

In a still further preferred embodiment of the invention, a computer program product for waking up at least one distributed printer includes instructions for a user interface on at least one computer, instructions for a wake up icon on the user interface, and instructions for a wake up command to be sent to the at least one distributed printer when the wake up icon is activated.

### BRIEF DESCRIPTION OF THE DRAWINGS

Other objects, features, and advantages of the present invention will become more fully apparent from the following detailed description of the preferred embodiment, the appended claims and the accompanying drawings in which:

FIG. 1 is a schematic diagram of the printer wake up icon apparatus of the present invention; and

FIG. 2 is a plan view of a desktop user interface illustrating the wake up icon of the present invention.

### DETAILED DESCRIPTION OF THE INVENTION

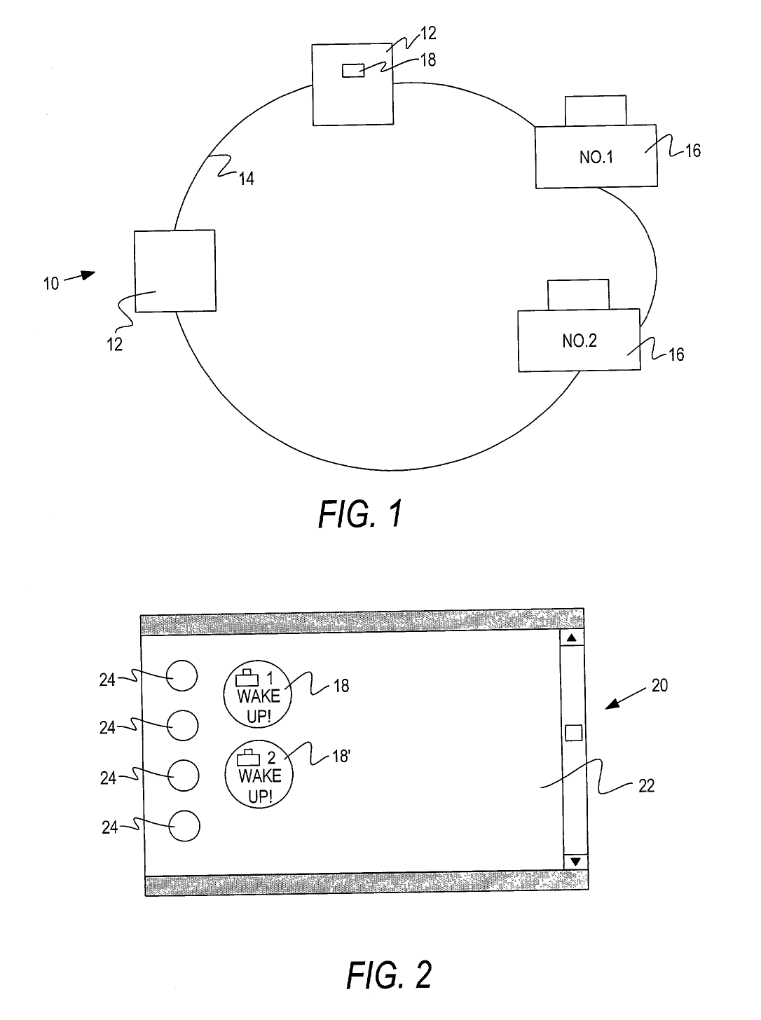

The preferred embodiment of the present invention is illustrated by way of example in FIGS. 1 and 2. With specific reference to FIG. 1, the printer wake up icon apparatus 10 of the present invention includes at least one computer 12 and a network 14. At least one printer 16 is connected to the network 14 and through the network 14 to the at least one computer 12. A wake up icon 18 is located on computer 12 for sending a wake up command to the printer 16.

As illustrated in FIG. 1, a preferred embodiment of the invention includes multiple computers 12 and/or multiple printers 16. In one aspect, multiple computers 12 are connected to a single printer 16. In another aspect, one or more computers 12 are connected to multiple printers 16.

In a further preferred embodiment of invention, network 12 is an intranet. Any intranet now known or hereafter developed is well within the scope of the invention. Again, intranets are common in many businesses whereby multiple users interface with and utilize remote, distributed printers 16. In another aspect of the invention, the network 12 is the Internet. Obviously, any derivative of the Internet as it is now known or hereafter developed is within the scope of the invention.

Referring now to FIG. 2, a representative user interface 20 is shown in the form of a computer desktop 22 as is known in the art. Computer desktop 22 provides a user interface 20 in a manner that is well known in that multiple icons 24 are arrayed for a user's convenience. These icons 24 are utilized, typically, as shortcuts to other programs commonly accessed by a computer 12 user. In accordance with the present invention, wake up icons 18 and 18′ are illustrated. Wake up icon 18 on user interface 20 is shown connected to printer No. 1. In operation, a user activates wake up icon 18 and sends a command to printer No. 1 to exit power save mode and warmup for printing. A user activates wake up icon 18, in accordance with the present invention, either before or during document creation. As a result, printer 16 is warmed up well in advance of a user's command to print the created document.

FIG. 2 also illustrates wake up icon 18′. Wake up icon 18′ is shown connected to printer No. 2. In this case, the user has a choice of where to send the prepared document and thus has a choice of which printer 16 to wake up prior to sending the document. Certainly, other forms of providing wake-up calls to multiple printers 16 are within the scope of those of ordinary skill in the art. For example, wake up icon 18 when activated by a user might include a pop-up list of choices of printers 16 from which the user chooses rather than having multiple wake-up icons 18 clutter the computer desktop 22 user interface 20.

The use of the printer wake up icon 10 of the present invention is simple and intuitive. The printer wake up icon 18 is added to a user's computer desktop 22 user interface 20 in a manner known in the art. Computer(s) 12 are connected to network 14 and thereby to printer(s) 16. Thereafter, a user simply activates wake up icon 18 before or during document preparation which sends a wake up command to the selected printer 16 well in advance of the print command the user sends when the document is ready to be printed. Obviously, wake up icon 18 works just as well for single user, single PC 12, single printer 16 situations via LAN or across a parallel cable, for example.

In one aspect of the invention, the wake up icon 18 is configurable. Icon 18 resides on one PC 12 for offices where printer 16 control is centralized and on multiple PCs 12 for offices where printer 12 control is a distributed function. There is no conflict with multiple wake up calls being sent to a single printer 12 at the same time. As a result, multiple icons 18 on multiple PCs 12 with multiple configurations are feasible and provides for at least the following scenarios.

Single printer wake ups/multiple icons: Having multiple icons 18 on the desktop of computer 12, with each icon 18 configured for a different, but single printer 16, allows the user to control which printer 16 is awakened for a given situation. Each icon 18 can be identified by name or picture for its printer 16 which makes selecting the correct icon 18 easy.

Multiple printer wake ups per icon: For administrators and power users, the icon 18 sends out wake up calls to multiple printers 16 based on a list of drivers it has been configured to connect through. In this way, any and all printers 16 the user may be considering will be awakened.

Timetable wake ups: The icon 18, as a background program, can be configured to wake up a single or multiple printers 16 at one or more given times of day i.e. 7:45 am just before the office opens and 12:45 just after lunch.

Program initiated wake ups: When attached to a program like MS Word or MS Excel, for example, the printer 16 can be sent the wake up signal whenever, and as, the programs (Word and Excel) are opened.

The description of the present embodiments of the invention have been presented for purposes of illustration, but are not intended to be exhaustive or to limit the invention to the form disclosed. Many modifications and variations will be apparent to those of ordinary skill in the art. As such, while the present invention has been disclosed in connection with the preferred embodiment thereof, it should be understood that there may be other embodiments which fall within the spirit and scope of the invention as defined by the following claims.

What is claimed is:

1. In a computer system of a networked computer and printer, a printer wake up icon apparatus comprising:
a) a computer;
b) a network connected to the computer;
c) a printer connected to the network and through the network to the computer; and
d) a wake up icon on said computer for sending a wake up command to the printer.

2. The apparatus of claim 1 wherein element a) comprises multiple computers connected to said printer.

3. The apparatus of claim 1 wherein element c) comprises multiple printers connected to said computer.

4. The apparatus of claim 1 wherein element a) comprises multiple computers and element c) comprises multiple printers.

5. The apparatus of claim 1 wherein said network is an intranet.

6. The apparatus of claim 1 wherein said network is the Internet.

7. The apparatus of claim 1 wherein said wake up icon resides on a desktop user interface on said computer.

8. In a computer system of networked computers and distributed printers, a printer wake up icon apparatus comprising:
a) at least one computer means, with a desktop user interface, for processing information;
b) a network means for connecting electronic devices connected to said at least one computer means;
c) a distributed printer means for printing hard copies of processed information connected to said at least one computer means through said network means; and
d) a printer wake up icon residing on said desktop user interface.

9. The apparatus of claim 8 wherein element a) comprises multiple computer means connected to said distributed printer means.

10. The apparatus of claim 8 wherein element c) comprises multiple distributed printer means.

11. The apparatus of claim 8 wherein said network means is an intranet.

12. The apparatus of claim 8 wherein said network means is the Internet.

13. In a computer system of at least one computer networked with a printer, a method of warming up the printer comprising the steps of:
a) providing at least one computer;
b) connecting the at least one computer to a network;
c) connecting a printer to the network and thereby to the at least one computer;
d) adding a wake up icon means to said at least one computer for sending a wake up signal to said printer;
e) activating the wake up icon means and sending a wake up signal to said printer before or during the preparation of information to be printed; and
f) sending the information to be printed to the printer.

14. The method of claim 13 wherein element a) comprises multiple computers.

15. The method of claim 13 wherein element c) comprises multiple printers.

16. The method of claim 13 wherein element b) comprises an intranet.

17. The method of claim 13 wherein element b) comprises the Internet.

18. The method of claim 13 wherein element d) comprises adding the wake up icon means to a desktop user interface on said at least one computer.

19. In a computer system network of at least one computer and at least one distributed printer, a computer program product for waking up the at least one distributed printer, the computer program product comprising:
a) instructions for a user interface on said at least one computer;
b) instructions for a wake up icon on said user interface; and
c) instructions for a wake up command to be sent to said at least one distributed printer when said wake up icon is activated.

20. The computer program product of claim 19 wherein element a) comprises multiple computers.
